(19) United States
(12) Patent Application Publication
(10) Pub. No.: US 2019/0323462 A1
(43) Pub. Date: Oct. 24, 2019

(54) STRUCTURE FOR MOUNTING INTAKE FLOW CONTROL VALVE

(71) Applicants: Hyundai Motor Company, Seoul (KR); Kia Motor Company, Seoul (KR)

(72) Inventors: Seung Jae KANG, Seoul (KR); Won Rok Choi, Seoul (KR)

(73) Assignees: Hyundai Motor Company, Seoul (KR); Kia Motor Company, Seoul (KR)

(21) Appl. No.: 16/136,834

(22) Filed: Sep. 20, 2018

(30) Foreign Application Priority Data
Apr. 19, 2018 (KR) 10-2018-0045612

(51) Int. Cl. F02M 35/10; F02M 26/70; F02M 26/21

(52) U.S. Cl. CPC F02M 35/10255; F02M 26/21; F02M 26/70; F02M 35/10222

(57) ABSTRACT

A structure for mounting an intake flow control valve may include an intake flow control valve which is disposed at an intake manifold which allows outside air to flow into a combustion chamber of an engine to control the flow of the outside air, an EGR gas passage, which allows EGR gas to flow into the intake manifold and is formed in the intake manifold; and a coolant passage, which allows a coolant of the engine to flow into the intake manifold, and is formed close to the EGR gas passage in the intake manifold.

### CROSS-REFERENCE TO RELATED APPLICATION

The present application claims priority to Korean Patent Application No. 10-2018-0045612 filed on Apr. 19, 2018, the entire contents of which is incorporated herein for all purposes by this reference.

### BACKGROUND OF THE INVENTION

### Field of the Invention

The present invention relates to a structure for mounting an intake flow control valve, and more particularly, the present invention relates to a structure for mounting an intake flow control valve capable of surely preventing a valve shaft from sticking.

### Description of Related Art

Conventionally, there has been a method of using swirl phenomenon and tumble phenomenon as a method of promoting fuel combustion in a combustion chamber of an engine.

The swirl phenomenon usually means accelerating the combust speed by forming a vortex in the air and the mixer being flowed into the combustion chamber.

Conventionally, an intake flow control valve (SCV; Swirl Control Valve) has been used to improve the combustion efficiency of an engine using the above-described swirl phenomenon.

A conventional intake flow control valve includes a valve shaft mounted in a direction intersecting the intake port on an intake manifold having an intake port communicating with a combustion chamber of the engine, a flap valve mounted on the valve shaft for adjusting the intake port, and an actuator that rotates the valve shaft to control the flap valve through the valve shaft.

On the other hand, exhaust gas recirculation (EGR), which recirculates a part of the exhaust gas to the combustion chamber to reduce the emissions of the harmful exhaust gas in the conventional engine, has been applied. In the exhaust gas recirculation, an exhaust gas recirculation passage is formed in the intake manifold because a part of the exhaust gas (EGR gas) is flowed back into the combustion chamber of the engine through the intake manifold.

The valve shaft of the intake flow control valve has been fitted with a rubber seal to prevent exhaust gas flowed into the intake manifold through the exhaust gas recirculation passage formed in the intake manifold from leaking to the outside through the valve shaft mounting portion of the intake flow control valve.

However, since the exhaust gas being flowed into the intake manifold is high temperature, there were concerns that the rubber seal is damaged from the heat of the exhaust gas so that the exhaust gas may be leaked to the outside through the damaged rubber seal, and also, the valve shaft mounting portion of the intake flow control valve in the intake manifold is thermally deformed due to the exhaust gas at high temperature so that the valve shaft is stuck to the intake manifold to cause inactivity, and additionally, since the exhaust gas recirculation passage formed at the intake manifold and the actuator mounting portion of the intake flow control valve are closely disposed due to the limited layout, the actuator of the intake flow control valve is damaged by the heat of the exhaust gas at high temperature.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a structure for mounting an intake flow control valve configured for surely preventing a valve shaft of an intake flow control valve from being stuck on an intake manifold by heat damage and improving combust efficiency by cooling an EGR gas being flowed into an intake manifold.

In a structure for mounting an intake flow control valve according to an exemplary embodiment of the present invention, an intake flow control valve may be disposed at an intake manifold which allows outside air to flow into a combustion chamber of an engine to control the flow of the outside air, an EGR gas passage, which allows EGR gas to flow into the intake manifold, may be formed in the intake manifold, and a coolant passage, which allows a coolant of the engine to flow into the intake manifold, may be formed close to the EGR gas passage in the intake manifold.

At least one intake passage may be formed at the intake manifold and the intake flow control valve may include a flap valve disposed at each intake passage to be rotatable to control the flow of the outside air flowing through the intake passage.

The intake flow control valve may include a valve shaft penetrating each flap valve and being mounted to be rotatable to control the movement of each flap valve and an actuator rotating the valve shaft.

A mounting hole may be formed in the intake manifold in a direction across the intake passage to install the valve shaft in the intake manifold and the mounting hole may include a large diameter portion having a diameter greater than the diameter of the valve shaft and a small diameter portion having a diameter relatively smaller than the diameter of the large diameter portion.

A bearing, which supports the valve shaft to be rotatable, may be provided at one end portion of the valve shaft.

A seal may be provided at one side surface of the intake manifold to prevent leakage of the outside air and the EGR gas through the mounting hole.

The seal and the bearing may be provided at an inlet of the large diameter portion, and the EGR gas passage and the coolant passage may be disposed close to the large diameter portion.

In accordance with a structure for mounting an intake flow control valve according to an exemplary embodiment of the present invention, the mounting hole for mounting the valve shaft of the intake flow control valve is formed at the intake manifold to be greater than the diameter of the valve shaft of the intake flow control valve, the valve shaft of the intake flow control valve is supported through the bearing to be rotatable, so that the valve shaft of the intake flow control valve is not stuck to the intake manifold, even if the intake manifold of aluminum material is thermally deformed, improving the operational reliability and durability of the intake flow control valve.

Furthermore, an engine coolant passage is formed close to the EGR gas passage formed in the intake manifold and the bearing mounting portion so that it is configured to effectively prevent the rubber seal for preventing the leakage of the EGR gas through the mounting hole, the bearing and the intake flow control valve from being damaged, and also, it is possible to improve cooling efficiency of the EGR gas and combust efficiency by further cooling the EGR gas through heat exchange between the coolant flowing along the coolant passage and the EGR gas being flowed into the intake manifold along the EGR gas passage.

Additionally, the overall temperature of the intake manifold is lowered through heat exchange between the coolant flowing along the coolant passage formed in the intake manifold and the intake manifold, improving the sealing performance of the intake manifold mounted on the cylinder head.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of an intake flow control valve mounted on an intake manifold according to an exemplary embodiment of the present invention;

FIG. 2 is a top plan view of an intake flow control valve mounted on an intake manifold according to an exemplary embodiment of the present invention;

FIG. 3 is a cross-sectional view taken along A-A line of FIG. 1; and

FIG. 4 is a cross-sectional view taken along B-B line of FIG. 2.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the other hand, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to accompanying drawings.

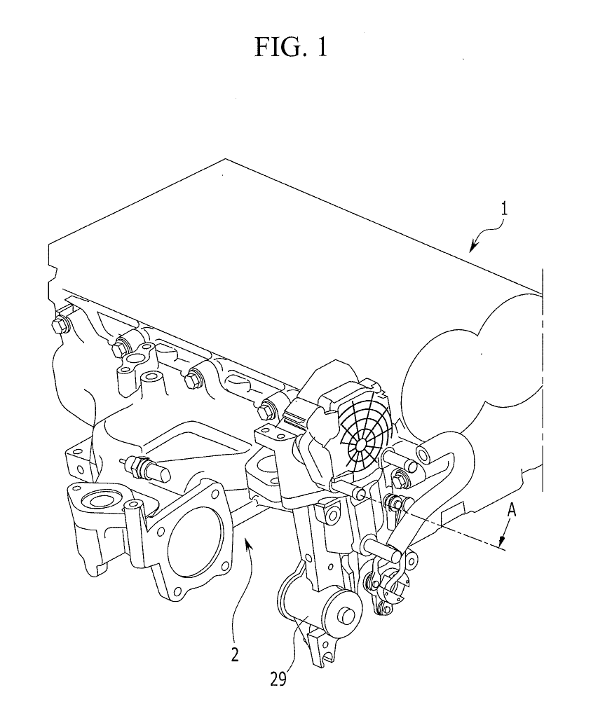

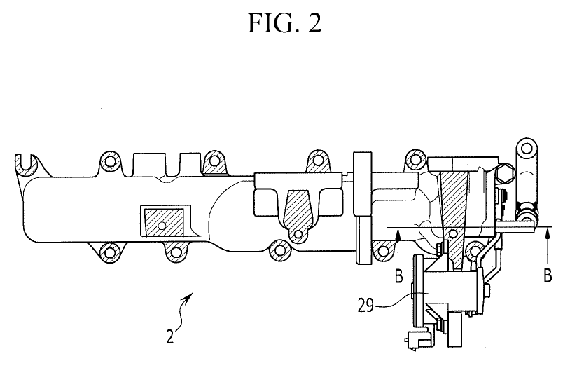

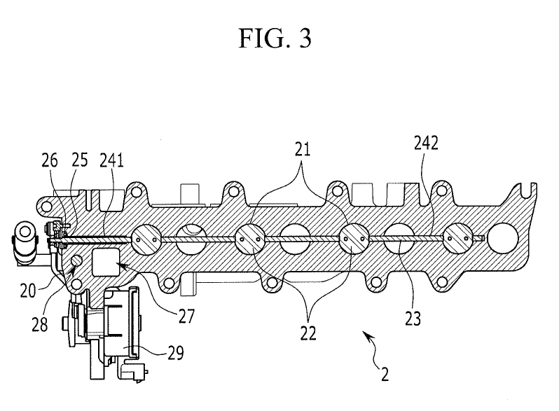

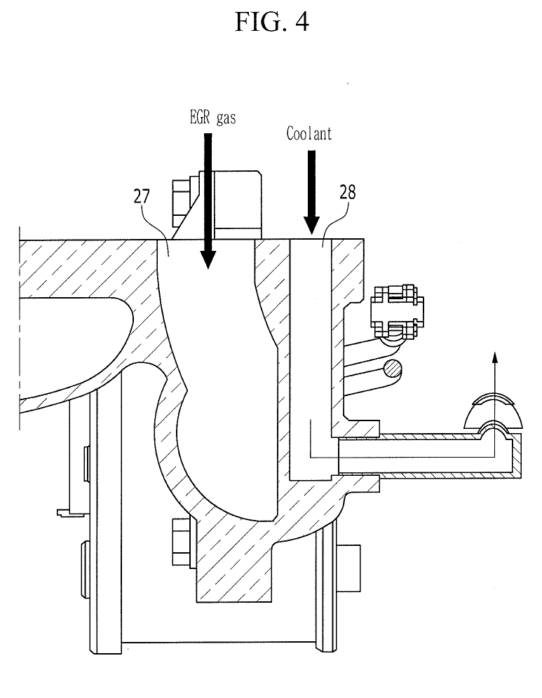

Referring to FIG. 1, FIG. 2, FIG. 3, and FIG. 4, a structure for mounting an intake flow control valve according to an exemplary embodiment of the present invention may be disposed at an intake manifold 2 mounted on a cylinder head 1.

At least one intake passage 21 may be formed in the intake manifold 2 to supply the outside air to the combustion chamber formed in the cylinder block. To control the flow of the outside air flowing through the intake passage 21, a flap valve 22 of an intake flow control valve may be configured to be rotatable at each intake passage 21.

To control the movement of each flap valve 22, each flap valve 22 may be mounted to rotate integrally with the valve shaft 23 penetrating each flap valve 22.

One end portion of the valve shaft 23 may be connected to an actuator 29, so that the valve shaft 23 and the flap valve 22 can rotate clockwise or anticlockwise according to the driving of the actuator 29 to adjust the intake flow flowed into the combustion chamber of the engine through the intake passage 21.

To mount the valve shaft 23 to the intake manifold 2, a mounting hole may be formed in the intake manifold 2 in a direction across the intake passage 21, and the mounting hole may penetrate one side surface 20 of the intake manifold 2 to extend toward the internal to the intake manifold 2.

The mounting hole may include a large diameter portion 241 greater than the diameter of the valve shaft 23 and a small diameter portion 242 smaller than that of the large diameter portion 241 but approximately similar to the diameter of the valve shaft.

The large diameter portion 241 may be formed between the one side surface 20 and the flap valve 22 closest to the one side surface 20. The large diameter portion 241 may be formed to have a sufficient size in consideration of thermal deformation so that the valve shaft 23 is not fixed to the intake manifold 2 even if the diameter of the large diameter portion 241 is reduced due to thermal deformation.

As like this, by forming the large diameter portion 241 in the intake manifold 2, it is possible to effectively prevent the valve shaft 23 from sticking to the large diameter portion 241 because the large diameter portion 241 is formed greater than the diameter of the valve shaft 23 even though the diameter of the large diameter portion 241 is reduced due to the thermal deformation of the intake manifold 2.

A bearing 25 may be disposed at one end portion of the valve shaft 23 so that the valve shaft 23 inserted into the large diameter portion 241 and the small diameter portion 242 does not shake to maintain a stable posture.

Furthermore, a seal 26 may be disposed on the one side surface 20 to prevent leakage of outside air and mixed gas of Exhaust gas recirculation (EGR) gas.

The seal 26 may be a rubber seal formed from a rubber material and disposed at the inlet of the mounting hole formed on the one side surface 20.

That is, the seal 26 and bearing 25 may be disposed close to the inlet of the large diameter portion 241.

Near to the large diameter portion 241, an EGR gas passage 27 may be formed in the intake manifold 2 to make the EGR gas to flow into the intake manifold 2.

The EGR gas passage 27 may be formed close to the large diameter portion 241.

As described above, when the EGR gas passage 27 is formed close to the large diameter portion 241, the thermal deformation of the large diameter portion 241 will get worse. It is necessary to prevent this appropriately.

Thus, in an exemplary embodiment of the present invention, a coolant passage 28 may be formed which is close to the EGR gas passage 27 to allow the coolant of the engine to flow into the internal to the intake manifold 2.

The coolant passage 28 may be formed to be positioned between the one side surface 20 and the EGR gas passage 27.

As like this, by forming the coolant passage 28 close to the EGR gas passage 27, a relatively low-temperature coolant flowing through the coolant passage 28 absorbs the high temperature exhaust gas heat flowing through the EGR gas passage 27 through indirect heat exchange via the intake manifold 2, it is possible to effectively prevent the thermal deformation of the large diameter portion 241, the bearing 25 and the seal 26, and also to improve the durability.

Furthermore, the coolant of the engine which is flowed through the coolant passage 28 to the intake manifold 2 relatively reduces the temperature of the EGR gas through heat exchange with the EGR gas flowing through the EGR gas passage 27, so that the combustion efficiency may be improved when the EGR gas is combusted and the overall temperature of the intake manifold 2 is reduced by the relatively low temperature engine coolant to improve the sealing performance at the mounting portion between the cylinder head 1 and intake manifold 2.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A structure for mounting an intake flow control valve, comprising:
the intake flow control valve disposed at an intake manifold and controlling outside air to flow into a combustion chamber of an engine by controlling a flow of the outside air into the intake manifold;
an exhaust gas recirculation (EGR) gas passage formed in the intake manifold, wherein EGR gas flows into the intake manifold through the EGR gas passage; and
a coolant passage formed adjacent to the EGR gas passage in the intake manifold, wherein a coolant of the engine flows into the intake manifold through the coolant passage.

2. The structure for mounting the intake flow control valve of claim 1,
wherein at least one intake passage is formed at the intake manifold; and
wherein the intake flow control valve includes a flap valve rotatably disposed at each intake passage of the at least one intake passage to control the flow of the outside air flowing through the at least one intake passage.

3. The structure for mounting the intake flow control valve of claim 2,
wherein the intake flow control valve further includes:
an actuator; and
a valve shaft penetrating the intake manifold and rotatably mounted to the intake manifold, wherein the valve shaft is connected to each flap valve and the actuator and is configured to control a movement of each flap valve according to motion of the actuator.

4. The structure for mounting the intake flow control valve of claim 3,
wherein a mounting hole is formed in the intake manifold in a direction across the at least an intake passage, the valve shaft mounted in the intake manifold by penetrating the mounting hole; and
wherein the mounting hole includes:
a first diameter portion having a diameter greater than a diameter of the valve shaft; and
a second diameter portion having a diameter smaller than a diameter of the first diameter portion.

5. The structure for mounting the intake flow control valve of claim 4, wherein the first diameter portion is formed between a side surface of the intake manifold and a flap valve closest to the side surface.

6. The structure for mounting the intake flow control valve of claim 4,
wherein a bearing rotatably supporting the valve shaft, is provided at an end portion of the valve shaft.

7. The structure for mounting the intake flow control valve of claim 6,
wherein the bearing is provided adjacent to the first diameter portion.

8. The structure for mounting the intake flow control valve of claim 6,
wherein a seal is provided at the side surface of the intake manifold to prevent leakage of the outside air and the EGR gas through the mounting hole.

9. The structure for mounting the intake flow control valve of claim 8,
wherein the seal is provided adjacent to the first diameter portion.

10. The structure for mounting the intake flow control valve of claim 9,
wherein the seal and the bearing are provided at an inlet of the first diameter portion.

11. The structure for mounting the intake flow control valve of claim 10,
wherein the EGR gas passage and the coolant passage are disposed adjacent to the inlet of the first diameter portion.

12. The structure for mounting the intake flow control valve of claim 1, wherein the coolant passage is formed to be positioned between a side surface of the intake manifold and the EGR gas passage.
